(19) United States
(12) Patent Application Publication
(10) Pub. No.: US 2011/0198089 A1
(43) Pub. Date: Aug. 18, 2011

(54) METHODS TO REDUCE SETTLING RATE OF SOLIDS IN A TREATMENT FLUID

(76) Inventors: Mohan K.R. Panga, Novosibirsk (RU); Bruno Drochon, Cambridge (GB); Isabelle Couillet, Paris (FR); Juan-Carlos Santamaria, Houston, TX (US); Peter J. Photos, El Campo, TX (US); John W. Still, Katy, TX (US)

(21) Appl. No.: 13/075,804

(22) Filed: Mar. 30, 2011

Related U.S. Application Data
(63) Continuation-in-part of application No. 12/551,081, filed on Aug. 31, 2009, now Pat. No. 7,923,415.

(51) Int. Cl. E21B 43/26; C09K 8/62; C09K 8/80

(52) U.S. Cl. 166/308.1; 507/200; 507/211; 507/216; 507/215; 507/213; 507/219

(57) ABSTRACT

The invention discloses a method of treating a subterranean formation of a well bore, comprising: providing a treatment fluid comprising a carrier fluid, proppant, a viscosifying agent and a viscosifier material, wherein the viscosifier material is inactive in a first state and is able to increase viscosity of the treatment fluid when in a second state; introducing the treatment fluid into the wellbore; and, allowing the treatment fluid to interact with a trigger able to activate the viscosifier material from first state to second state.

### CROSS-REFERENCE TO RELATED APPLICATIONS

This application is a continuation-in-part application of application Ser. No. 12/551,081, now U.S. Pat. No. 7,923,415, entitled “METHODS TO REDUCE SETTLING RATE OF SOLIDS IN A TREATMENT FLUID” filed on Aug. 31, 2009, which is hereby in its entirety incorporated by reference.

### FIELD OF THE INVENTION

The invention relates to methods for treating subterranean formations. More particularly, the invention relates to methods for reducing the settling rate of particulate material in a fluid.

### BACKGROUND

The statements in this section merely provide background information related to the present disclosure and may not constitute prior art.

Hydrocarbons (oil, condensate, and gas) are typically produced from wells that are drilled into the formations containing them. For a variety of reasons, such as inherently low permeability of the reservoirs or damage to the formation caused by drilling and completion of the well, the flow of hydrocarbons into the well is undesirably low. In this case, the well is “stimulated” for example using hydraulic fracturing, chemical (usually acid) stimulation, or a combination of the two (called acid fracturing or fracture acidizing).

In hydraulic and acid fracturing, a first, viscous fluid called the pad is typically injected into the formation to initiate and propagate the fracture. This is followed by a second fluid that contains a proppant to keep the fracture open after the pumping pressure is released. Granular proppant materials may include sand, ceramic beads, or other materials. In “acid” fracturing, the second fluid contains an acid or other chemical such as a chelating agent that can dissolve part of the rock, causing irregular etching of the fracture face and removal of some of the mineral matter, resulting in the fracture not completely closing when the pumping is stopped. Occasionally, hydraulic fracturing can be done without a highly viscosified fluid (i.e., slick water) to minimize the damage caused by polymers or the cost of other viscosifiers.

In gravel packing, gravel is placed in the annulus of screen and formation/casing to control sand production. A carrier fluid is used to transport gravel from the surface to the formation where the gravel has to be placed. Typically two types of carrier fluids are used. The first is a brine with a low concentration of gravel (1 lb per gal of brine) and the second is a viscous fluid with high concentration of gravel (5 lb per gal of brine). Several types of viscosifiers are used to increase the viscosity of the fluid. These include polymers such as HEC, Xanthan, Guar etc and viscoelastic surfactants.

The transport of solids (proppant, gravel, or other particulate material) from the surface to the required depth in the well plays an important role in well stimulations. A common problem that occurs during solids transport is the setting of solids due to difference in densities of the fluid and the solid particles. If the solids start settling before the fluid reaches its destination, several problems can occur including screen outs, incomplete gravel packs, wellbore blockage, stuck tools etc. To reduce the settling rate, the carrier fluid is typically viscosified using polymers or surfactants. However, increasing the viscosity of the fluid at the surface can increase the friction pressure significantly.

Methods disclosed herewith offer a new way to viscosify the fluid while it is under downhole conditions.

### SUMMARY

A method of treating a subterranean formation of a well bore is disclosed. The method comprises providing a treatment fluid comprising a carrier fluid, proppant, a viscosifying agent and a viscosifier material, wherein the viscosifier material is inactive in a first state and is able to increase viscosity of the treatment fluid when in a second state; introducing the treatment fluid into the wellbore; and, allowing the treatment fluid to interact with a trigger able to activate the viscosifier material from first state to second state.

The treatment fluid may further have a degradable or particulate material. In one embodiment, the degradable or particulate material has a first average particle size and the degradable particulate material has a second average particle size, wherein the second average particle size is between three to twenty times smaller than the first average particle size. The second average particle size may be between five to ten times smaller than the first average particle size. In a second embodiment, the degradable particulate material has further an amount of particulates having a third average particle size, wherein the third average particle size is between three to twenty times smaller than the second average particle size. The third average particle size may be between five to ten times smaller than the second average particle size.

In one alternative, the trigger may be temperature. The viscosifier material may be a polysaccharide polymer.

In a second alternative, the trigger is pH, triggered by acid or basic condition. The viscosifier material may be an acid soluble polymer which increases viscosity of the treatment fluid when in acid pH. The acid soluble polymer may be chitosan, chitosan derivative, polyimide, copolymer of vinyl pyridine, copolymer of acrylic and/or methacrylic acid or a mixture thereof. The treatment fluid may further have an acid precursor and the step of providing the trigger is done by releasing acid from the acid precursor. The acid precursor can be encapsulated. The treatment fluid may further have an acid and the step of providing the trigger is done by releasing acid. The acid can be encapsulated. The treatment fluid may further have a degradable particulate material and the acid precursor would be the degradable particulate material. The viscosifier material may be a base soluble polymer which increases viscosity of the treatment fluid when in base pH. The base soluble polymer may be copolymer containing maleic anhydride, alkali swellable latex or a mixture thereof. The treatment fluid may further have a base precursor and the step of providing the trigger is done by releasing base from the base precursor. The base precursor can be encapsulated. The treatment fluid may further have a base and the step of providing the trigger is done by releasing base. The base can be encapsulated.

In a fourth aspect, a composition for use in a subterranean formation of a well bore is disclosed. The composition comprises: a fluid, a particulate material, and a viscosifier material; wherein the viscosifier material is inactive in a first state and is able to increase viscosity of the composition when in a second state stimulated by a trigger.

The composition may further comprise a degradable or particulate material. In one embodiment, the particulate material has a first average particle size and the degradable particulate material has a second average particle size, wherein the second average particle size is between three to twenty times smaller than the first average particle size. The second average particle size may be between five to ten times smaller than the first average particle size. In a second embodiment, the degradable particulate material has further an amount of particulates having a third average particle size, wherein the third average particle size is between three to twenty times smaller than the second average particle size. The third average particle size may be between five to ten times smaller than the second average particle size.

In one alternative, the trigger may be temperature. The viscosifier material may be a polysaccharide polymer.

In a second alternative, the trigger is pH, triggered by acid or basic condition. The viscosifier material may be an acid soluble polymer which increases viscosity of composition when in acid pH. The acid soluble polymer may be chitosan, chitosan derivative, polyimide, copolymer of vinyl pyridine, copolymer of acrylic and/or methacrylic acid or a mixture thereof. The composition may further comprise an acid precursor or an acid. The acid precursor or acid can be encapsulated. The composition may further comprise a degradable particulate material and the acid precursor would be the degradable particulate material. The viscosifier material may be a base soluble polymer which increases viscosity of the composition when in base pH. The base soluble polymer may be copolymer containing maleic anhydride, alkali swellable latex or a mixture thereof. The composition may further comprise a base precursor or a base. The base precursor or base can be encapsulated

### BRIEF DESCRIPTION OF THE DRAWINGS

FIG. 1 shows an illustration of some embodiments.

FIG. 2 shows treatment fluid to use some embodiments.

FIG. 3A shows a high solid fraction fluid. FIG. 3B shows a low solid fraction fluid.

FIG. 4A shows a high solid fluid with a pH/temperature viscosifier material in the first state. FIG. 4B shows the viscosifier material in the second state.

FIG. 5 shows viscosity profile of the viscosifier material in the second state for different temperatures.

### DETAILED DESCRIPTION

At the outset, it should be noted that in the development of any actual embodiments, numerous implementation-specific decisions must be made to achieve the developer's specific goals, such as compliance with system and business related constraints, which can vary from one implementation to another. Moreover, it will be appreciated that such a development effort might be complex and time consuming but would nevertheless be a routine undertaking for those of ordinary skill in the art having the benefit of this disclosure.

The description and examples are presented solely for the purpose of illustrating embodiments of the invention and should not be construed as a limitation to the scope and applicability of the invention. In the summary of the invention and this detailed description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range disclosed and enabled the entire range and all points within the range.

The following definitions are provided in order to aid those skilled in the art in understanding the detailed description.

The term “treatment”, or “treating”, refers to any subterranean operation that uses a fluid in conjunction with a desired function and/or for a desired purpose. The term “treatment”, or “treating”, does not imply any particular action by the fluid.

The term “fracturing” refers to the process and methods of breaking down a geological formation and creating a fracture, i.e. the rock formation around a well bore, by pumping fluid at very high pressures, in order to increase production rates from a hydrocarbon reservoir. The fracturing methods otherwise use conventional techniques known in the art.

The term “surfactant” refers to a soluble or partially soluble compound that reduces the surface tension of liquids, or reduces interfacial tension between two liquids, or a liquid and a solid by congregating and orienting itself at these interfaces.

The term “viscoelastic” refers to those viscous fluids having elastic properties, i.e., the liquid at least partially returns to its original form when an applied stress is released.

The phrase “viscoelastic surfactant” or “VES” refers to that class of compounds which can form micelles (spherulitic, anisometric, lamellar, or liquid crystal) in the presence of counter ions in aqueous solutions, thereby imparting viscosity to the fluid. Anisometric micelles can be used, as their behavior in solution most closely resembles that of a polymer.

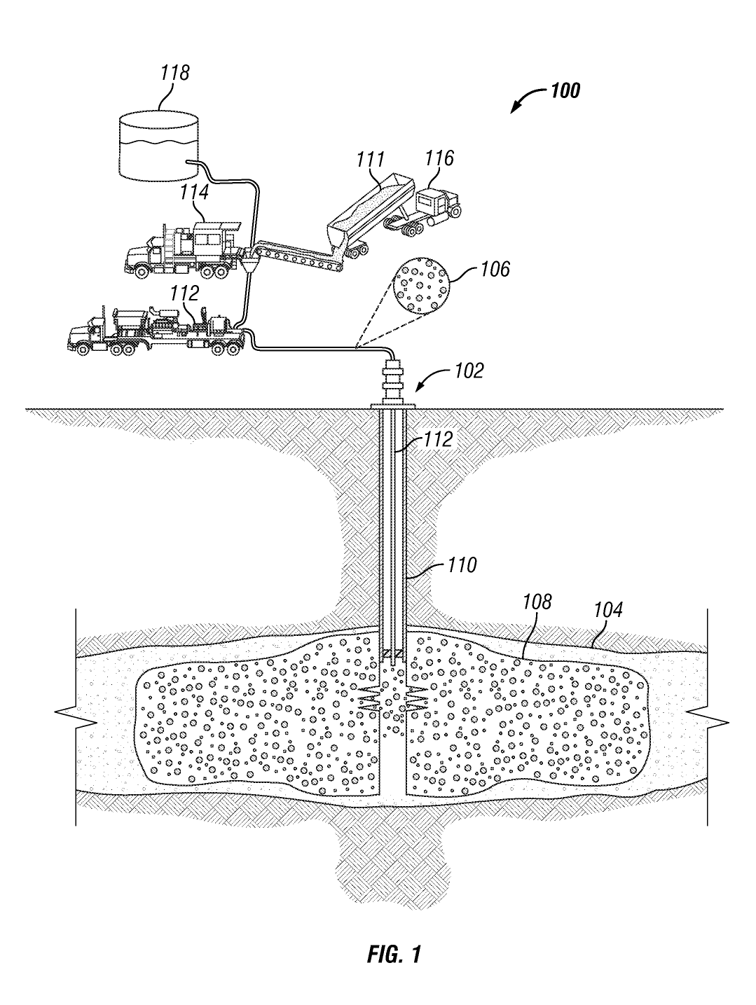

FIG. 1 is a schematic diagram of a system 100 used in a method of reducing settling rate of a high solid content fluid. The system 100 includes a wellbore 102 in fluid communication with a formation of interest 104. The formation of interest 104 may be any formation wherein fluid communication between a wellbore and the formation is desirable, including a hydrocarbon-bearing formation, a water-bearing formation, a formation that accepts injected fluid for disposal, pressurization, or other purposes, or any other formation understood in the art. According to embodiments disclose herewith the formation of interest is a shale formation, especially a shale gas formation.

Shale gas, also known as gas shale, is conventional natural gas that is produced from reservoirs predominantly composed of shale with lesser amounts of other fine grained rocks rather than from more conventional sandstone or limestone reservoirs. The gas shales are often both the source rocks and the reservoir for the natural gas, which can be stored in three ways: adsorbed onto insoluble organic matter called kerogen, trapped in the pore spaces of the fine-grained sediments interbedded with the gas shale or confined in fractures within the shale itself.

Gas shales can be thick and laterally extensive. Drilling and production of gas shales in many cases is very similar to that for conventional natural gas reservoirs; however, due to lack of permeability, gas shales generally require more fracture stimulation.

The system 100 further includes a treatment fluid 106 that includes a fluid having optionally a low amount of a viscosifying agent. The treatment fluid can be embodied as a fracturing slurry wherein the fluid is a carrier fluid. The carrier fluid includes any base fracturing fluid understood in the art. Some non-limiting examples of carrier fluids include hydratable gels (e.g. guars, poly-saccharides, xanthan, hydroxy-ethyl-cellulose, etc.), a cross-linked hydratable gel, a viscosified acid (e.g. gel-based), an emulsified acid (e.g. oil outer phase), an energized fluid (e.g. an N₂ or CO₂ based foam), and an oil-based fluid including a gelled, foamed, or otherwise viscosified oil. Additionally, the carrier fluid may be a brine, and/or may include a brine. While the treatment fluid 106 described herein includes proppant, the system 100 may further include certain stages of fracturing fluids with alternate mixtures of particulates.

A low amount of viscosifying agent specifically indicates a lower amount of viscosifier than conventionally is included for a fracture treatment. The loading of the viscosifier, for example described in pounds of gel per 1,000 gallons of carrier fluid, is selected according to the particulate size (due to settling rate effects) and loading that the fracturing slurry must carry, according to the viscosity required to generate a desired fracture 108 geometry, according to the pumping rate and casing 110 or tubing 112 configuration of the wellbore 102, according to the temperature of the formation of interest 104, and according to other factors understood in the art. In certain embodiments, the low amount of the viscosifier includes a hydratable gelling agent in the carrier fluid at less than 20 pounds per 1,000 gallons of carrier fluid where the amount of particulates in the fracturing slurry are greater than 16 pounds per gallon of carrier fluid. In certain further embodiments, the low amount of the viscosifier includes a hydratable gelling agent in the carrier fluid at less than 20 pounds per 1,000 gallons of carrier fluid where the amount of particulates in the fracturing slurry are greater than 23 pounds per gallon of carrier fluid. In certain embodiments, a low amount of the viscosifier includes a visco-elastic surfactant at a concentration below 1% by volume of carrier fluid. In certain embodiments a low amount of the viscosifier includes values greater than the listed examples, because the circumstances of the system 100 conventionally utilize viscosifier amounts much greater than the examples. For example, in a high temperature application with a high proppant loading, the carrier fluid may conventionally indicate the viscosifier at 50 lbs of gelling agent per 1,000 gallons of carrier fluid, wherein 40 lbs of gelling agent, for example, may be a low amount of viscosifier. One of skill in the art can perform routine tests of fracturing slurries 106 based on certain particulate blends 111 in light of the disclosures herein to determine acceptable viscosifier amounts for a particular embodiment of the system 100.

According to some embodiments, the viscosifying agent may be a polysaccharide such as substituted galactomannans, such as guar gums, high-molecular weight polysaccharides composed of mannose and galactose sugars, or guar derivatives such as hydroxypropyl guar (HPG), carboxymethylhydroxypropyl guar (CMHPG) and carboxymethyl guar (CMG), hydrophobically modified guars, guar-containing compounds.

According to some embodiments, the viscosifying agent may be a synthetic polymer such as polyvinyl polymers, polymethacrylamides, cellulose ethers, lignosulfonates, and ammonium, alkali metal, and alkaline earth salts thereof. More specific examples of other typical water soluble polymers are acrylic acid-acrylamide copolymers, acrylic acid-methacrylamide copolymers, polyacrylamides, partially hydrolyzed polyacrylamides, partially hydrolyzed polymethacrylamides, polyvinyl alcohol, polyalkyleneoxides, other galactomannans, heteropolysaccharides obtained by the fermentation of starch-derived sugar and ammonium and alkali metal salts thereof.

According to some embodiments, the viscosifying agent may be a cellulose derivative such as hydroxyethylcellulose (HEC) or hydroxypropylcellulose (HPC), carboxymethylhydroxyethylcellulose (CMHEC) and carboxymethycellulose (CMC).

According to some embodiments, the viscosifying agent may be a biopolymer such as xanthan, diutan, and scleroglucan.

According to some embodiments, the viscosifying agent may be a viscoelastic surfactant (VES). The VES may be selected from the group consisting of cationic, anionic, zwitterionic, amphoteric, nonionic and combinations thereof. Some non-limiting examples are those cited in U.S. Pat. Nos. 6,435,277 (Qu et al.) and 6,703,352 (Dahayanake et al.), each of which are incorporated herein by reference. The viscoelastic surfactants, when used alone or in combination, are capable of forming micelles that form a structure in an aqueous environment that contribute to the increased viscosity of the fluid (also referred to as “viscosifying micelles”). These fluids are normally prepared by mixing in appropriate amounts of VES suitable to achieve the desired viscosity. The viscosity of VES fluids may be attributed to the three dimensional structure formed by the components in the fluids. When the concentration of surfactants in a viscoelastic fluid significantly exceeds a critical concentration, and in most cases in the presence of an electrolyte, surfactant molecules aggregate into species such as micelles, which can interact to form a network exhibiting viscous and elastic behavior.

In general, particularly suitable zwitterionic surfactants have the formula:

RCONH—(CH₂(CH₂CH₂O)ₘ(CH₂)_{b}—-N⁺(CH₃)₂—(CH₂)_{a′}(CH₂CH₂O)_{m′}(CH₂)_{b′}COO⁻

in which R is an alkyl group that contains from about 11 to about 23 carbon atoms which may be branched or straight chained and which may be saturated or unsaturated; a, b, a′, and b′ are each from 0 to 10 and m and m′ are each from 0 to 13; a and b are each 1 or 2 if m is not 0 and (a+b) is from 2 to 10 if m is 0; a′ and b′ are each 1 or 2 when m′ is not 0 and (a′+b′) is from 1 to 5 if m is 0; (m+m′) is from 0 to 14; and CH₂CH₂O may also be OCH₂CH₂. In some embodiments, a zwitterionic surfactants of the family of betaine is used.

Exemplary cationic viscoelastic surfactants include the amine salts and quaternary amine salts disclosed in U.S. Pat. Nos. 5,979,557, and 6,435,277 which are hereby incorporated by reference. Examples of suitable cationic viscoelastic surfactants include cationic surfactants having the structure:

R₁N⁺(R₂)(R₃)(R₄) X⁻

in which R₁ has from about 14 to about 26 carbon atoms and may be branched or straight chained, aromatic, saturated or unsaturated, and may contain a carbonyl, an amide, a retroamide, an imide, a urea, or an amine; R₂, R₃, and R₄ are each independently hydrogen or a C₁ to about C₆ aliphatic group which may be the same or different, branched or straight chained, saturated or unsaturated and one or more than one of which may be substituted with a group that renders the R₂, R₃, and R₄ group more hydrophilic; the R₂, R₃ and R₄ groups may be incorporated into a heterocyclic 5- or 6-member ring structure which includes the nitrogen atom; the R₂, R₃ and R₄ groups may be the same or different; R₁, R₂, R₃ and/or R₄ may contain one or more ethylene oxide and/or propylene oxide units; and X⁻ is an anion. Mixtures of such compounds are also suitable. As a further example, R₁ is from about 18 to about 22 carbon atoms and may contain a carbonyl, an amide, or an amine, and R₂, R₃, and R₄ are the same as one another and contain from 1 to about 3 carbon atoms.

Amphoteric viscoelastic surfactants are also suitable. Exemplary amphoteric viscoelastic surfactant systems include those described in U.S. Pat. No. 6,703,352, for example amine oxides. Other exemplary viscoelastic surfactant systems include those described in U.S. Pat. Nos. 6,239,183; 6,506,710; 7,060,661; 7,303,018; and 7,510,009 for example amidoamine oxides. These references are hereby incorporated in their entirety. Mixtures of zwitterionic surfactants and amphoteric surfactants are suitable. An example is a mixture of about 13% isopropanol, about 5% 1-butanol, about 15% ethylene glycol monobutyl ether, about 4% sodium chloride, about 30% water, about 30% cocoamidopropyl betaine, and about 2% cocoamidopropylamine oxide.

The viscoelastic surfactant system may also be based upon any suitable anionic surfactant. In some embodiments, the anionic surfactant is an alkyl sarcosinate. The alkyl sarcosinate can generally have any number of carbon atoms. Alkyl sarcosinates can have about 12 to about 24 carbon atoms. The alkyl sarcosinate can have about 14 to about 18 carbon atoms. Specific examples of the number of carbon atoms include 12, 14, 16, 18, 20, 22, and 24 carbon atoms. The anionic surfactant is represented by the chemical formula:

R₁CON(R₂)CH₂X

wherein R₁ is a hydrophobic chain having about 12 to about 24 carbon atoms, R₂ is hydrogen, methyl, ethyl, propyl, or butyl, and X is carboxyl or sulfonyl. The hydrophobic chain can be an alkyl group, an alkenyl group, an alkylarylalkyl group, or an alkoxyalkyl group. Specific examples of the hydrophobic chain include a tetradecyl group, a hexadecyl group, an octadecentyl group, an octadecyl group, and a docosenoic group.

According to some embodiments, the viscosifying agent may be an associative polymer for which viscosity properties are enhanced by suitable surfactants and hydrophobically modified polymers. For example, it may be a charged polymer in the presence of a surfactant having a charge that is opposite to that of the charged polymer, the surfactant being capable of forming an ion-pair association with the polymer resulting in a hydrophobically modified polymer having a plurality of hydrophobic groups, as described in published application U.S. 20040209780A1, Harris et. al.

The viscosifying agent is combined with the carrier fluid in an amount between about 0.001% to about 5% by weight, or between about 0.01% to about 4% by weight, or between about 0.1% to about 2.5% by weight.

In certain embodiments, the carrier fluid includes an acid. The fracture 108 is illustrated as a traditional hydraulic double-wing fracture, but in certain embodiments may be an etched fracture and/or wormholes such as developed by an acid treatment. The carrier fluid may include hydrochloric acid, hydrofluoric acid, ammonium bifluoride, formic acid, acetic acid, lactic acid, glycolic acid, maleic acid, tartaric acid, sulfamic acid, malic acid, citric acid, methyl-sulfamic acid, chloro-acetic acid, an amino-poly-carboxylic acid, 3-hydroxypropionic acid, a poly-amino-poly-carboxylic acid, and/or a salt of any acid. In certain embodiments, the carrier fluid includes a poly-amino-poly-carboxylic acid, and is a trisodium hydroxyl-ethyl-ethylene-diamine triacetate, mono-ammonium salts of hydroxyl-ethyl-ethylene-diamine triacetate, and/or mono-sodium salts of hydroxyl-ethyl-ethylene-diamine tetra-acetate. The selection of any acid as a carrier fluid depends upon the purpose of the acid—for example formation etching, damage cleanup, removal of acid-reactive particles, etc., and further upon compatibility with the formation 104, compatibility with fluids in the formation, and compatibility with other components of the fracturing slurry and with spacer fluids or other fluids that may be present in the wellbore 102.

The treatment fluid includes proppant. Proppant involves many compromises imposed by economical and practical considerations. Criteria for selecting the proppant type, size, and concentration is based on the needed dimensionless conductivity, and can be selected by a skilled artisan. Such proppants can be natural or synthetic (including but not limited to glass beads, ceramic beads, sand, and bauxite), coated, or contain chemicals; more than one can be used sequentially or in mixtures of different sizes or different materials. The proppant may be resin coated, or pre-cured resin coated. Proppants and gravels in the same or different wells or treatments can be the same material and/or the same size as one another and the term proppant is intended to include gravel in this disclosure. In general the proppant used will have an average particle size of from about 0.15 mm to about 2.39 mm (about 8 to about 100 U.S. mesh), more particularly, but not limited to 0.25 to 0.43 mm (40/60 mesh), 0.43 to 0.84 mm (20/40 mesh), 0.84 to 1.19 mm (16/20), 0.84 to 1.68 mm (12/20 mesh) and 0.84 to 2.39 mm (8/20 mesh) sized materials. Normally the proppant will be present in the slurry in a concentration of from about 0.12 to about 0.96 kg/L, or from about 0.12 to about 0.72 kg/L, or from about 0.12 to about 0.54 kg/L.

Suitable proppants can include sand, gravel, glass beads, ceramics, bauxites, glass, and the like or combinations thereof. Also other proppants like, plastic beads such as styrene divinylbenzene, and particulate metals may be used. Proppant used in this application may not necessarily require the same permeability properties as typically required in conventional treatments because the overall fracture permeability will at least partially develop from formation of channels. Other proppants may be materials such as drill cuttings that are circulated out of the well. Also, naturally occurring particulate materials may be used as proppants, including, but are not necessarily limited to: ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc, some nonlimiting examples of which are proppants made of walnut hulls impregnated and encapsulated with resins. Further information on some of the above-noted compositions thereof may be found in Encyclopedia of Chemical Technology, Edited by Raymond E. Kirk and Donald F. Othmer, Third Edition, John Wiley & Sons, Volume 16, pages 248-273 (entitled “Nuts”), Copyright 1981, which is incorporated herein by reference. Resin coated (various resin and plastic coatings) or encapsulated proppants having a base of any of the previously listed propping materials such as sand, ceramics, bauxite, nut shells, etc. may be used in accordance with the invention. Essentially, the proppant can be any material that will hold open the propped portion of the fracture.

The proppant can include elongated proppant. An important parameter for suitable materials for elongated proppant is a suitable material deformability, the ability of a material to deform without breaking (failure) under the action of load. Material deformability may be measured as the degree of deformation in a large number of tests, for example tension, compression, torsion, bending etc. In some cases, the loading force is applied in such a way that uniform deformation is sustained, and the direction of the applied force does not change during the entire process of loading (the geometrically linear case). Also a very important property of the elongated proppant particles is the curvature.

Some useful shapes of elongated particles are rods, ovals, plates and disks. The shapes of the elongated particles need not necessarily fit into any of these categories, i.e. the elongated particles may have irregular shapes. While described are elongated particles such as rods or elongated rods, any elongated shape, for example rods, ovals, plates and disks may be useful. The maximum length-based aspect ratio of the individual elongated particles should be less than about 25. In this discussion, when we refer to elongated particles, we intend the term to refer to stiff, non-deformable particles having an aspect ratio of less than about 25. The elongated particles are preferably made from ceramic materials the same as or similar to those used in conventional intermediate and high strength ceramic proppants. However, any material may be used that has the proper physical properties, in particular Young's Modulus. Particularly suitable materials include ceramics such as glass, bauxite ceramic, mullite ceramic, and metals such as aluminum and steels such as carbon steel, stainless steel, and other steel alloys.

Some suitable sizes for the elongated particles are as follows. If the particles can be characterized most straightforwardly as cylinders or fibers (with the understanding that these and other characterizations may be approximations of the shapes and the actual shapes may be irregular), then the “lengths” may range from about 0.1 mm to about 30 mm, and the “diameters” from about 0.1 mm to about 10 mm, preferably from about 0.1 mm to about 3 mm. If the particles can be characterized most straightforwardly as disks or plates, then the “thickness” may range from about 10 microns to about 5000 microns and the “diameter” may range from about 0.5 mm to about 25 mm, or the “length” may range from about 1 mm to about 20 mm and the “width” may range from about 1 mm to about 20 mm. The elongated particles may be used with any natural or synthetic proppant or gravel. For rods (fibers) the ratio of the diameter of the elongated particle to the diameter of the conventional (spherical) proppant may range from about 0.1 to about 20; the preferred ratio ranges from about 0.5 to about 3. For plates or disks, the ratio of the diameter of the conventional proppant to the thickness of the elongated particle may range from about 1 to about 100; the preferred ratio is from about 4 to about 20; the optimal value is about 5. For plates or disks, the ratio of the diameter of the conventional proppant to the thickness of the plate or disk may range from about 1 to about 100; the preferred range is from about 3 to about 20; the optimal is about 5. For plates or disks, the ratio of the length or width of the plate or disk to the diameter of the conventional proppant may range from about 1 to about 50; the preferred range of the ratio is from about 5 to about 10.

In one embodiment, the treatment fluid 106 comprises proppant and particulate materials with defined particles size distribution. On example of realization is disclosed in U.S. publication number 2009-0025934, herewith incorporated by reference, for a treatment fluid being a fracturing slurry. The fracturing slurry may include a first amount of particulates having a first average particle size between about 100 and 2000 μm. In certain embodiments, the first amount of particulates may be a proppant, for example sand, ceramic, or other particles understood in the art to hold a fracture 108 open after a treatment is completed. In certain embodiments, the first amount of particulates may be a fluid loss agent, for example calcium carbonate particles or other fluid loss agents known in the art. The fracturing slurry may further include a second amount of particulates having a second average particle size between about three times and about ten times smaller than the first average particle size. For example, where the first average particle size is about 100 μm (an average particle diameter, for example), the second average particle size may be between about 5 μm and about 33 μm. In certain embodiments, the second average particle size may be between about seven and twenty times smaller than the first average particle size.

In a second embodiment, the selection of the size of the second amount of particulates is dependent upon maximizing the packed volume fraction (PVF) of the mixture of the first amount of particulates and the second amount of particulates. A second average particle size of between about five to ten times smaller than the first amount of particulates contributes to maximizing the PVF of the mixture, but a size between about three to ten times smaller, and in certain embodiments between about three to twenty times smaller, will provide a sufficient PVF for most systems. Further, the selection of the size of the second amount of particulates is dependent upon the composition and commercial availability of particulates of the type comprising the second amount of particulates. For example, where the second amount of particulates comprise wax beads, a second average particle size of four times (4×) smaller than the first average particle size rather than seven times (7×) smaller than the first average particle size may be used if the 4× embodiment is cheaper or more readily available and the PVF of the mixture is still sufficient to acceptably suspend the particulates in the carrier fluid.

In a third embodiment, the fracturing slurry further includes a third amount of particulates having a third average particle size that is smaller than the second average particle size. In this third embodiment the PVF of the mixture of the first amount of particulates, the second amount of particulates and the third amount of particulates may be optimized or maximized. A third average particle size of between about five to ten times smaller than the second amount of particulates contributes to maximizing the PVF of the mixture, but a size between about three to ten times smaller, and in certain embodiments between about three to twenty times smaller, will provide a sufficient PVF for most systems. In certain further embodiments, the fracturing slurry 106 may have a fourth or a fifth amount of particles. For the purposes of optimizing the PVF of the fracturing slurry 106, more than three or four particles sizes will not typically be required. Additional particles may be added for other reasons, such as the chemical composition of the additional particles, the ease of manufacturing certain materials into the same particles versus into separate particles, the commercial availability of particles having certain properties, and other reasons understood in the art.

In certain embodiments, the system 100 includes a pumping device 112 structured to create a fracture 108 in the formation of interest 104 with the slurry 106. The system 100 in certain embodiments further includes peripheral devices such as a blender 114, a particulates hauler 116, fluid storage tank(s) 118, and other devices understood in the art. In certain embodiments, the carrier fluid may be stored in the fluid storage tank 118, or may be a fluid created by mixing additives with a base fluid in the fluid storage tank 118 to create the carrier fluid. The particulates may be added from a conveyor 120 at the blender 114, may be added by the blender 114, and/or may be added by other devices (not shown). In certain embodiments, one or more sizes of particulates may be pre-mixed into the particulate blend 111. For example, if the system 100 includes a first amount, second amount, and third amount of particulates, a particulate blend 111 may be premixed and include the first amount, second amount, and third amount of particulates. In certain embodiments, one or more particulate sizes may be added at the blender 114 or other device. For example, if the system 100 includes a first amount, second amount, and third amount of particulates, a particulate blend 111 may be premixed and include the first amount and second amount of particulates, with the third amount of particulates added at the blender 114.

In certain embodiments, the treatment fluid 106 includes a degradable material. In certain embodiments, the degradable material is making up at least part of the second amount of particulates. For example, the second amount of particulates may be completely made from degradable material, and after the fracture treatment the second amount of particulates degrades and flows from the fracture 108 in a fluid phase. In another example, the second amount of particulates includes a portion that is degradable material, and after the fracture treatment the degradable material degrades and the particles break up into particles small enough to flow from the fracture 108. In certain embodiments, the second amount of particulates exits the fracture by dissolution into a fluid phase or by dissolution into small particles and flowing out of the fracture.

The treatment fluid 106 includes a viscosifier material, inactive in a first state and able to increase the viscosity of the fracturing slurry 106 in a second state. The activation from the first state to the second state is made by a trigger. In certain embodiments, the trigger is pH or temperature. In other embodiments, the trigger may be salinity, pressure or other mechanical modification.

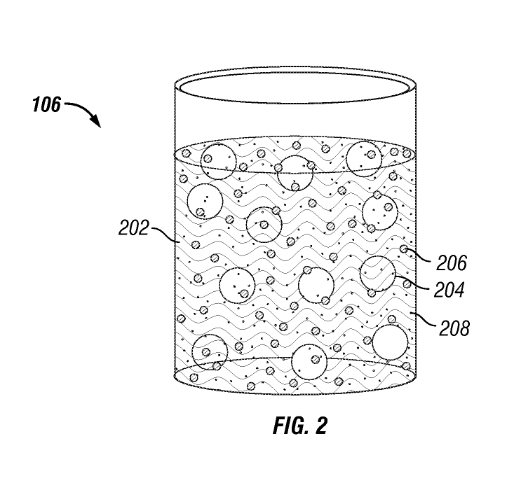

FIG. 2 is an illustration of a treatment fluid 106. The treatment fluid 106 includes a fluid 202, at least a first amount of particulate material 204 and at least a second amount of viscosifier material 208. In certain further embodiments the treatment fluid 106 further includes at least a third amount of degradable particulates 206. Optionally, the particulates are combined to optimize the PVF. In certain embodiments, the particulates 204, 206, 208 combine to have a PVF above 0.70 or above 0.80. In certain further embodiments the particulates 204, 206, 208 may have a much higher PVF approaching 0.95.

The degradable material 206 in certain embodiments comprises a wax, an oil-soluble resin, and/or a material soluble in hydrocarbons. In certain embodiments, the degradable material 206 includes at least one of a lactide, a glycolide, an aliphatic polyester, a poly (lactide), a poly (glycolide), a poly (ε-caprolactone), a poly (orthoester), a poly (hydroxybutyrate), an aliphatic polycarbonate, a poly (phosphazene), and a poly (anhydride). In certain embodiments, the degradable material includes at least one of a poly (saccharide), dextran, cellulose, chitin, chitosan, a protein, a poly (amino acid), a poly (ethylene oxide), and a copolymer including poly (lactic acid) and poly (glycolic acid). In certain embodiments, the degradable material includes a copolymer including a first moiety which includes at least one functional group from a hydroxyl group, a carboxylic acid group, and a hydrocarboxylic acid group, the copolymer further including a second moiety comprising at least one of glycolic acid and lactic acid.

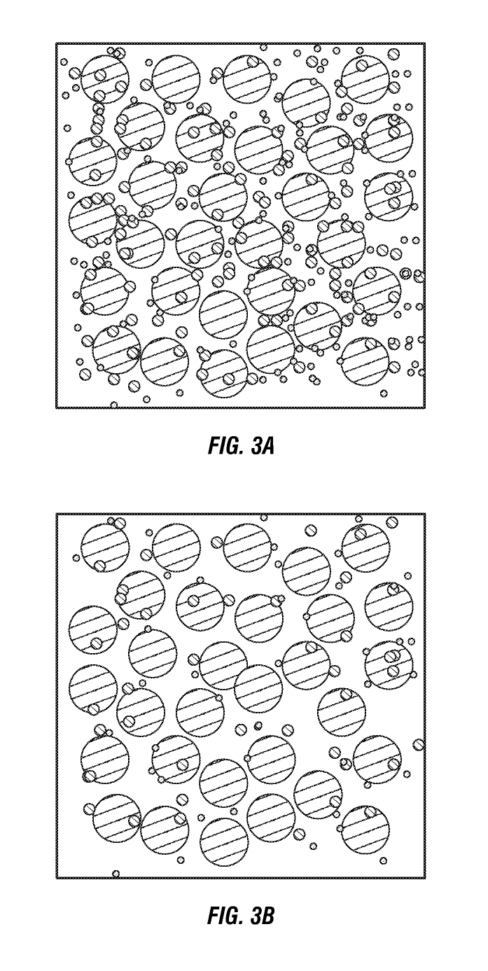

The treatment fluid typically contains sand and degradable particles of different sizes, optionally having PVF optimized. FIG. 3A is an illustration of the treatment fluid according to one embodiment with a high solid fraction. The sand is suspended in solution due to hindered settling. The settling rate of sand is a function of the solid fraction in the slurry. For the sand to be suspended for a long period of time it is essential to have a high solid phase volume in the slurry. FIG. 3B is an illustration of the treatment fluid according to a second embodiment with a low solid fraction. This slurry shown will settle at a much faster rate than the slurry in previous embodiment.

One example of a high solid content fluid for the treatment fluid is: sand, polyglycolic acid (PGA) in water. The sand has an average particle size of 800 μm and is present at 48% in volume. The PGA is in two particle sizes: a first average particle size of 150 μm and a second average particle size of 8 μm. The first particle size is present at 8% in volume and the second particle size is present at 16% in volume. The de-ionized water is present at 29% in volume. The PVF of this treatment fluid is 0.71.

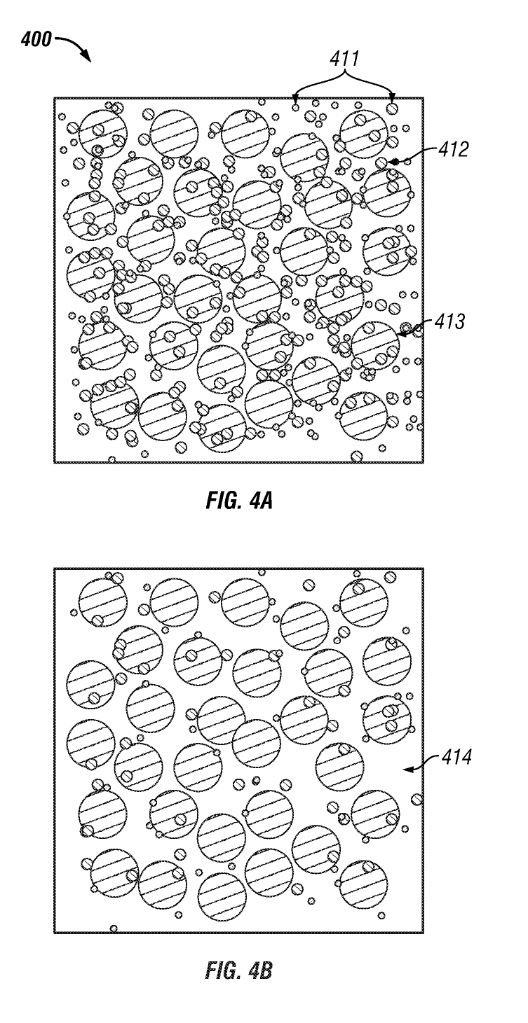

FIGS. 4A and 4B are an illustration of the mechanism of the method of treatment according to certain embodiments. After the treatment fluid or slurry 400 is place downhole, the degradable particles 411 turn into liquid state. This reduces the solid fraction in the slurry thereby accelerating the settling rate of sand. To reduce the settling rate of sand 413 once the slurry is placed downhole, the solution is viscosified using a pH or temperature triggered viscosifier material 412. As shown in FIG. 4A, pH or temperature triggered particles that increase viscosity when they dissolve are added to the treatment fluid. After the treatment fluid is placed downhole, the increase in settling rate due to decrease in solid volume fraction is compensated by the increase in viscosity of the solution from dissolution of the pH or temperature triggered viscosifier material. The viscosifier material goes from a first solid state 413 to a second liquid state 414. The pH triggered viscosifier material dissolves in water when PGA hydrolyzes and releases acid. If a temperature triggered viscosifier is used, the liquid phase viscosity increases as soon as the treatment fluid is placed downhole, thanks to increase of temperature between surface and downhole.

In a first embodiment, the viscosifier material is an acid soluble polymer which is added to the treatment fluid along with an acid precursor. The acid precursor can be one of the degradable particles in the slurry. The acid soluble polymer is in the form of a solid particle at surface conditions. As the acid soluble polymers are solid particles having an average particle size, they can be included in the optimization process of PVF. After the slurry is placed downhole, the acid precursor releases acid and changes the pH of the solution. The acid soluble polymer particles dissolve in the fluid increasing the viscosity of the fluid. Examples of acid soluble polymers include chitosan or chitosan derivatives such as the N-carboxybutyl chitosan or the N-carboxymethyl chitosan, polyimides such as the examples described in U.S. patents number 6,379,865 or 6,559,245, incorporated herewith by reference, copolymers of vinyl pyridine as those described in U.S. Pat. No. 7,294,347, incorporated herewith by reference, or copolymers of acrylic and/or methacrylic acid or mixture of those polymers.

In a second embodiment, the viscosifier material is an acid soluble polymer which is added to the treatment fluid along with an encapsulated acid or acid precursors. The acid soluble polymer is of the type as disclosed in first embodiment. The acid required for triggering the dissolution of the acid soluble polymer is added to the mixture as the encapsulated acid or acid precursors. The encapsulated acid or acid precursors release acid once the slurry reaches downhole. Examples include encapsulated PLA, PGA other hydroxy acids, citric, glycolic, maleic acid/anhydride etc. Encapsulated material can be a solid polymer acid precursor. Examples of solid polymer acid precursors that may be used include homopolymers of lactic acid, glycolic acid, hydroxybutyrate, hydroxyvalerate and epsilon caprolactone, random copolymers of at least two of lactic acid, glycolic acid, hydroxybutyrate, hydroxyvalerate, epsilon caprolactone, L-serine, L-threonine, L-tyrosine, block copolymers of at least two of polyglycolic acid, polylactic acid, hydroxybutyrate, hydroxyvalerate, epsilon caprolactone, L-serine, L-threonine, L-tyrosine, homopolymers of ethylenetherephthalate (PET), butylenetherephthalate (PBT) and ethylenenaphthalate (PEN), random copolymers of at least two of ethylenetherephthalate, butylenetherephthalate and ethylenenaphthalate, block copolymers of at least two of ethylenetherephthalate, butylenetherephthalate, ethylenenaphthalate and combinations of these. Some of the encapsulated material may include acrylics, halocarbon, polyvinyl alcohol, Aquacoat® aqueous dispersions, hydrocarbon resins, polyvinyl chloride, Aquateric® enteric coatings, hydroxypropyl cellulose (HPC), polyvinylacetate phthalate, hydroxypropyl methyl cellulose (HPMC), polyvinylidene chloride, hydroxylpropyl methyl cellulose phthalate (HPMCP), proteins, Kynar®, fluoroplastics, rubber (natural or synthetic), caseinates, maltodextrins, shellac, chlorinated rubber, silicone, polyvinyl acetate phtalate (e.g. Coateric®) coatings, microcrystalline wax, starches, coating butters, milk solids, stearines, polyvinyl dichloride (Daran®) latex, molasses, sucrose, dextrins, nylon, surfactants, Opadry® coating systems, Surelease® coating systems, enterics, paraffin wax, Teflon® fluorocarbons, Eudragits® polymethacrylates, phenolics, waxes, ethoxylated vinyl alcohol, vinyl alcohol copolymer, polylactides, zein, fats, polyamino acids, fatty acids, polyethylene gelatin, polyethylene glycol, glycerides, polyvinyl acetate, vegetable gums and polyvinyl pyrrolidone.

In a third embodiment, the viscosifier material is a base soluble polymer which is added to the treatment fluid along with a base precursor or a weak base. The slurry containing sand and base soluble polymer particles and the base precursor is injected to the formation. The base soluble polymer dissolves in the fluid because of increase in pH from the base precursor increasing the viscosity of the slurry. The sand settling rate is reduced and after the treatment the dissolved polymer particles create void spaces in the pack. Examples of base soluble polymers include copolymers containing maleic anhydride. One such example is a copolymer of maleic anhydride and isobutylene that is manufactured by Kuraray Company and is sold under the trade name of ISOBAM. Other examples include alkali swellable latex as described in U.S publication number 2008/0190615, incorporated herewith by reference. Examples of pH increasing agents include urea and its derivatives, weak bases, hydroxides and oxides of alkali and alkaline earth metals, encapsulated bases that could be released into the fluid downhole.

In a fourth embodiment, the viscosifier material is polymer particle that dissolves at high temperature. The treatment fluid comprises sand, water/brine and polymer particles that dissolves at high temperature. The slurry is used to carry sand from the surface to a subterranean formation. After the sand reaches its destination, its settling rate is slowed down by the increase in viscosity resulting from the dissolution of polymer particles into the brine at high temperature. Examples of high temperature soluble polymer are polysaccharides such as locust bean, cellulose, sodium carboxymethyl cellulose, starch, konjac, agaroid and any derivatives of those materials.

In some embodiment, the treatment fluid may comprise fiber material. A first type of fiber additive can provide reinforcement and consolidation of the proppant. This fiber type can include, for example, glass, ceramics, carbon and carbon-based compounds, metals and metallic alloys, and the like and combinations thereof, as a material that is packed in the proppant to strengthen the proppant pillars. In other applications, a second type of fiber can be used that further inhibits settling of the proppant in the treatment fluid. The second fiber type can include, for example, polylactic acid, polyglycolic acid, polyethylterephthalate (PET), polyol, and the like and combinations thereof, as a material that inhibits settling or dispersion of the proppant in the treatment fluid and serves as a primary removable fill material in the spaces between the pillars. Yet other applications include a mixture of the first and second fiber types, the first fiber type providing reinforcement and consolidation of the proppant and the second fiber type inhibiting settling of the proppant in the treatment fluid.

The fibers can be hydrophilic or hydrophobic in nature. Hydrophilic fibers are preferred in one embodiment. Fibers can be any fibrous material, such as, but not necessarily limited to, natural organic fibers, comminuted plant materials, synthetic polymer fibers (by non-limiting example polyester, polyaramide, polyamide, novoloid or a novoloid-type polymer), fibrillated synthetic organic fibers, ceramic fibers, inorganic fibers, metal fibers, metal filaments, carbon fibers, glass fibers, ceramic fibers, natural polymer fibers, and any mixtures thereof. Particularly useful fibers are polyester fibers coated to be highly hydrophilic, such as, but not limited to, DACRON® polyethylene terephthalate (PET) Fibers available from Invista Corp. Wichita, Kans., USA, 67220. Other examples of useful fibers include, but are not limited to, polylactic acid polyester fibers, polyglycolic acid polyester fibers, polyvinyl alcohol fibers, and the like.

In some embodiments, the treatment fluids may optionally further comprise additional additives, including, but not limited to, acids, fluid loss control additives, gas, corrosion inhibitors, breakers, scale inhibitors, catalysts, clay control agents, biocides, friction reducers, combinations thereof and the like. For example, in some embodiments, it may be desired to foam the treatment fluid using a gas, such as air, nitrogen, or carbon dioxide. In one certain embodiment, the treatment fluids may contain a particulate additive, such as a particulate scale inhibitor.

The treatment fluids may be used for carrying out a variety of subterranean treatments, including, but not limited to, drilling operations, fracturing treatments, and completion operations (e.g., gravel packing) In some embodiments, the treatment fluids may be used in treating a portion of a subterranean formation. In certain embodiments, a treatment fluid may be introduced into a well bore that penetrates the subterranean formation. Optionally, the treatment fluid further may comprise particulates and other additives suitable for treating the subterranean formation. For example, the treatment fluid may be allowed to contact the subterranean formation for a period of time. In some embodiments, the treatment fluid may be allowed to contact hydrocarbons, formations fluids, and/or subsequently injected treatment fluids. After a chosen time, the treatment fluid may be recovered through the well bore. In certain embodiments, the treatment fluids may be used in fracturing treatments.

The method is also suitable for gravel packing, or for fracturing and gravel packing in one operation (called, for example frac and pack, frac-n-pack, frac-pack, StimPac treatments, or other names), which are also used extensively to stimulate the production of hydrocarbons, water and other fluids from subterranean formations. These operations involve pumping a slurry of in hydraulic fracturing or gravel in gravel packing. In low permeability formations, the goal of hydraulic fracturing is generally to form long, high surface area fractures that greatly increase the magnitude of the pathway of fluid flow from the formation to the wellbore. In high permeability formations, the goal of a hydraulic fracturing treatment is typically to create a short, wide, highly conductive fracture, in order to bypass near-wellbore damage done in drilling and/or completion, to ensure good fluid communication between the rock and the wellbore and also to increase the surface area available for fluids to flow into the wellbore.

In certain embodiments, the treatment fluids may be used for providing some degree of sand control in a portion of the subterranean formation. In the sand control embodiments, the treatment fluid is introduced into the well bore that penetrates the subterranean formation such that the particulates form a gravel pack in or adjacent to a portion of the subterranean formation.

To facilitate a better understanding of the invention, the following examples of embodiments are given. In no way should the following examples be read to limit, or define, the scope of the invention.

### EXAMPLES

A series of experiments were conducted to demonstrate method of treatment according to the invention.

### Example 1

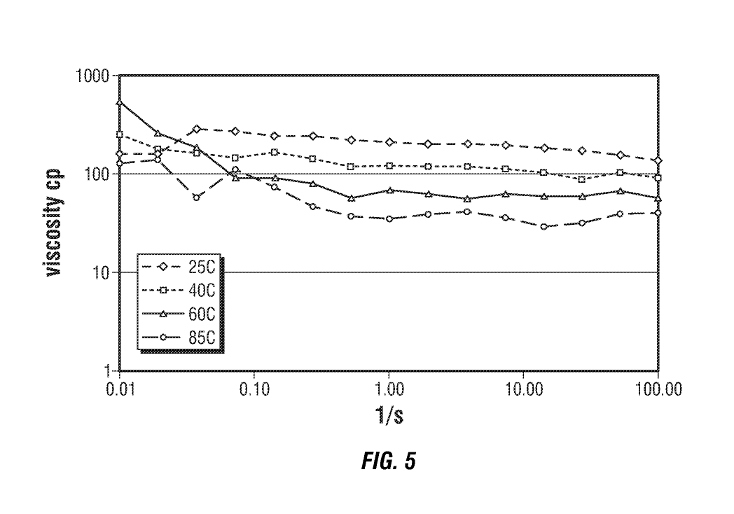

Two mixtures containing 80 mL de-ionized (DI) water and 0.64 g of high molecular weight chitosan polymer particles were prepared. The pH of one of the mixtures was adjusted to pH=2.28 using glycolic acid. The bottles were heated in the oven at 65.5° C. (150° F.) for 45 min. The two mixtures were analyzed after heating under static conditions. It can be seen that the chitosan particles in the pH adjusted mixture have dissolved completely whereas the chitosan particles in the DI water mixture have settled to the bottom. The viscosity of the pH adjusted sample is shown in FIG. 5. It can seen that the viscosity of the final solution is lot higher than the initial mixture (DI water viscosity is lcp) as the chitosan dissolved in DI water at low pH.

### Example 2

Three slurries were prepared using sand (800 μm), polylactic acid (PLA, 150 μm), silica powder (3 μm), chitosan particles and DI water. The composition of the slurries is shown in Table 1.

TABLE 1

| Component | Slurry A1 (g) | Slurry A2 (g) | Slurry A3 (g) |
|---|---|---|---|
| Sand (800 μm) | 101.76 | 101.76 | 101.76 |
| PLA (150 μm) | 12 | 12 | 12 |
| Silica (3 μm) | 29.68 | 29.68 | 29.68 |
| DI Water | 20.8 | 20.8 | 20.8 |
| Chitosan | NA | 0.4 | 0.8 |

The slurries were aged in the oven at 121.1° C. (250° F.) for 24 hours. Slurry A1 has three phases after 24 h; a bottom layer containing a settled mixture of sand, PLA and silica powder, a middle layer of fluid containing the 3 μm silica powder and a top layer of free water. In slurries A2 and A3, not much settling is observed due to increase in solution viscosity resulting from the dissolution of chitosan particles as PLA hydrolyzes and decreases the pH.

The amount of free water on the top of the settled mixture after 24 hrs at 121.1° C. (250° F.) is measured to compare the settling rate of each of the slurries and the results are shown in Table 2 below.

TABLE 2

| Fluid | Free water (mL) |
|---|---|
| Slurry A1 | 15 |
| Slurry A2 | 1 |
| Slurry A3 | 2 |

The data in Table 2 shows that addition of chitosan particles to the slurry help in decreasing the settling rate of solids.

### Example 3

Two slurries containing PLA, silica and DI water were prepared according to Table 3 composition. In slurry B2, chitosan polymer particles were added to reduce the settling rate of silica. The PLA particles were added to decrease the pH of the solution at high temperature so that chitosan particles can dissolve in the fluid and increase viscosity. The settling of silica in the two slurries after heating them for 24 hrs at 93.3° C. (200° F.) was analyzed. The silica in slurry B2 is settling at a much lower rate than the silica in slurry B1.

TABLE 3

| Component | Slurry B1 (g) | Slurry B2 (g) |
|---|---|---|
| PLA (150 μm) | 17.7 | 17.7 |
| Silica (3 μm) | 42.9 | 42.9 |
| DI Water | 171 | 171 |
| Chitosan | 0 | 0.9 |

The amount of free water on the top of the settling mixture is shown in Table 4 below.

TABLE 4

| Fluid | Total Volume (ml) | Free Water (ml) |
|---|---|---|
| Slurry B1 | 200 | 130 |
| Slurry B2 | 200 | 80 |

### Example 4

One gram of ISOBAM particles are added to DI water and the pH of the fluid was increased to 12 using NaOH. The ISOBAM particles dissolved completely after 94 h at room temperature increasing the viscosity of the solution. The mixture of lgm of ISOBAM particles in 25 mL of DI water at pH=12 before and after dissolution of ISOBAM particles were analyzed. After 94 h the ISOBAM particles dissolved completely.

### Example 5

A slurry was prepared using sand (800 μm), PGA (150 μm), PGA (8 μm), a base precursor or a pH buffer such as MgO, alkali swellable latex and water. The slurry is placed downhole and the pH of the slurry increases as the base precursor releases the base into solution. The alkali swellable latex viscosifies the solution as soon as the water becomes alkaline. The increase in viscosity reduces the settling rate of sand.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

What is claimed is:

1. A method of treating a subterranean formation of a well bore, comprising:
a. providing a treatment fluid comprising a carrier fluid, proppant, a viscosifying agent and a viscosifier material, wherein the viscosifier material is inactive in a first state and is able to increase viscosity of the treatment fluid when in a second state;
b. introducing the treatment fluid into the wellbore; and,
c. allowing the treatment fluid to interact with a trigger able to activate the viscosifier material from first state to second state.

2. The method of claim 1, wherein the treatment fluid further comprises a degradable or a particulate material.

3. The method of claim 2, wherein the proppant has a first average particle size and the degradable or particulate material has a second average particle size, wherein the second average particle size is between three to twenty times smaller than the first average particle size.

4. The method of claim 3, wherein the second average particle size is between five to ten times smaller than the first average particle size.

5. The method of claim 3, wherein the degradable or particulate material has further an amount of particulates having a third average particle size, wherein the third average particle size is between three to twenty times smaller than the second average particle size.

6. The method of claim 5, wherein the third average particle size is between five to ten times smaller than the second average particle size.

7. The method of claim 1, wherein the viscosifying agent is selected from the group consisting of substituted galactomannans, guar gums, high-molecular weight polysaccharides composed of mannose and galactose sugars, guar derivatives, hydroxypropyl guar (HPG), carboxymethylhydroxypropyl guar (CMHPG) and carboxymethyl guar (CMG), hydrophobically modified guars, guar-containing compounds, hydroxyethylcellulose (HEC), hydroxypropylcellulose (HPC), carboxymethylhydroxyethylcellulose (CMHEC), carboxymethycellulose (CMC), xanthan, diutan, scleroglucan and mixtures thereof.

8. The method of claim 1, wherein the viscosifying agent is viscoelastic surfactant.

9. The method of claim 1, wherein the trigger is temperature.

10. The method of claim 1, wherein the trigger is pH.

11. The method of claim 10, wherein the viscosifier material is an acid soluble polymer which increases viscosity of the treatment fluid when in acid pH.

12. The method of claim 11, wherein the acid soluble polymer is chitosan, chitosan derivative, polyimide, copolymer of vinyl pyridine, copolymer of acrylic and/or methacrylic acid or a mixture thereof.

13. The method of claim 11, wherein the treatment fluid further comprises an acid precursor and the step of providing the trigger is done by releasing acid from the acid precursor.

14. The method of claim 13, wherein the acid precursor is encapsulated.

15. The method of claim 11, wherein the treatment fluid further comprises an acid and the step of providing the trigger is done by releasing acid.

16. The method of claim 15, wherein the acid is encapsulated.

17. The method of claim 10, wherein the viscosifier material is a base soluble polymer which increases viscosity of the treatment fluid when in base pH.

18. The method of claim 17, wherein the base soluble polymer is copolymer containing maleic anhydride, alkali swellable latex or a mixture thereof.

19. The method of claim 17, wherein the treatment fluid further comprises a base precursor and the step of providing the trigger is done by releasing base from the base precursor.

20. The method of claim 19, wherein the base precursor is encapsulated.

21. The method of claim 17, wherein the treatment fluid further comprises a base and the step of providing the trigger is done by releasing base.

22. The method of claim 21, wherein the base is encapsulated.

23. The method of claim 1, further comprising allowing the trigger to activate the viscosifier material to increase viscosity of the treatment fluid such that the settling rate of the proppant in the treatment fluid is reduced.

24. The method of claim 2, further comprising allowing the trigger to activate the viscosifier material to increase viscosity of the treatment fluid such that the settling rate of the proppant, degradable and/or particulate material in the treatment fluid is reduced.

25. The method of claim 1, further comprising allowing the trigger to activate the viscosifier material to increase viscosity of the treatment fluid such that the settling rate of the proppant in the treatment fluid is unchanged.

26. The method of claim 2, further comprising allowing the trigger to activate the viscosifier material to increase viscosity of the treatment fluid such that the settling rate of the proppant, degradable and/or particulate material in the treatment fluid is unchanged.

27. A method of treating a subterranean formation comprising at least in part shale formation, comprising:
a. providing a treatment fluid comprising a carrier fluid, proppant and a viscosifier material, wherein the viscosifier material is inactive in a first state and is able to increase viscosity of the treatment fluid when in a second state;
b. introducing the treatment fluid into the wellbore; and,
c. allowing the treatment fluid to interact with a trigger able to activate the viscosifier material from first state to second state.

28. The method of claim 27, wherein the treatment fluid further comprises a degradable or a particulate material.

29. The method of claim 27, wherein the treatment fluid further comprises a viscosifying agent.

30. The method of claim 27, further comprising allowing the trigger to activate the viscosifier material to increase viscosity of the treatment fluid such that the settling rate of the proppant in the treatment fluid is reduced.

31. The method of claim 28, further comprising allowing the trigger to activate the viscosifier material to increase viscosity of the treatment fluid such that the settling rate of the proppant, degradable and/or particulate material in the treatment fluid is reduced.

32. The method of claim 27, further comprising allowing the trigger to activate the viscosifier material to increase viscosity of the treatment fluid such that the settling rate of the proppant in the treatment fluid is unchanged.

33. The method of claim 28, further comprising allowing the trigger to activate the viscosifier material to increase viscosity of the treatment fluid such that the settling rate of the proppant, degradable and/or particulate material in the treatment fluid is unchanged.

34. A method of fracturing a subterranean formation of a well bore, comprising:
a. providing a fracturing fluid comprising a carrier fluid, proppant and a viscosifier material, wherein the viscosifier material is inactive in a first state and is able to increase viscosity of the treatment fluid when in a second state;
b. introducing the fracturing fluid into the wellbore;
c. initiating a fracture in the subterranean formation; and,
d. allowing the fracturing fluid to interact with a trigger able to activate the viscosifier material from first state to second state.
